(19) United States
(12) Patent Application Publication
(10) Pub. No.: US 2026/0205766 A1
(43) Pub. Date: Jul. 16, 2026

(54) TECHNIQUES FOR DISTANCE BASED FEEDBACK FOR DEVICE-TO-DEVICE COMMUNICATIONS

(71) Applicant: QUALCOMM Incorporated, San Diego, CA (US)

(72) Inventors: Tien Viet NGUYEN, Bridgewater, NJ (US); Hui GUO, Beijing (CN); Gabi SARKIS, San Diego, CA (US); Dan VASSILOVSKI, Del Mar, CA (US); Qing LI, Princeton Junction, NJ (US); Kapil GULATI, Belle Mead, NJ (US); Shuanshuan WU, San Diego, CA (US)

(21) Appl. No.: 19/135,694

(22) PCT Filed: Feb. 20, 2023
(86) PCT No.: PCT/CN2023/077092

§ 371 Date: Jun. 4, 2025

(51) Int. Cl. H04W 4/021; H04W 24/08; H04W 64/00; H04W 72/25; H04W 92/18

(52) U.S. Cl. CPC H04W 4/021; H04W 24/08; H04W 64/00; H04W 72/25; H04W 92/18

(57) ABSTRACT

Methods, systems, and devices for wireless communications are described. Groupcast vehicle-to-everything (V2X) messages may include a control portion (e.g., a sidelink control information (SCI)-1 or SCI-2) and a data portion. Proximity information may be provided through an indication of a zone identifier (ID) of the transmitting vehicle, which may be a 12-bit value with 6-bits that indicate the X-direction and 6-bits that indicate the Y-direction. Additionally, a destination ID for a V2X transmission may indicate a super-zone. The super-zone, combined with the zone ID, can unambiguously identify multiple zones associated with a transmission, such that wrap-around in adjacent zones based on zone ID alone will not prompt a receiving vehicle (e.g., a receiving UE or a receiving device) to report feedback to a transmitting vehicle (e.g., a transmitting UE or a transmitting device).

### CROSS REFERENCE

The present Application is a 371 national phase filing of International PCT Application No. PCT/CN2023/077092 by NGUYEN et al., entitled “TECHNIQUES FOR DISTANCE BASED FEEDBACK FOR DEVICE-TO-DEVICE COMMUNICATIONS,” filed Feb. 20, 2023, which is assigned to the assignee hereof, and which is expressly incorporated by reference in its entirety herein.

### FIELD OF DISCLOSURE

The present disclosure, for example, relates to wireless communications systems, more particularly to techniques for distance based feedback for device-to-device communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for distance based feedback for device-to-device communications. For example, the described techniques provide for resolution of zone ID ambiguity in vehicle-to-everything (V2X) groupcast messages intended for vehicles within a proximity to the transmitting vehicle. Groupcast V2X messages may include a control portion (e.g., a sidelink control information (SCI)-1 and/or SCI-2) and a data portion. If a receiving vehicle receives the control portion but not the data portion, the receiving vehicle may send a negative acknowledgment (NACK) back to the transmitting vehicle to initiate retransmission. If a receiving vehicle receives both the control portion and data portion, no feedback may be transmitted. Proximity information may be provided through an indication of a zone identifier (ID) of the transmitting vehicle, which may be a 12-bit value with 6-bits that indicate the X-direction and 6-bits that indicate the Y-direction. Such a proximity information indication design results in zone-IDs that wrap around every 2⁶n meters where n is the resolution size (e.g., with a 20 meter X/Y resolution, wrap-around occurs every 1280 meters in the X and Y directions). Additionally, a destination ID for a V2X transmission may indicate a super-zone. The super-zone, combined with the zone ID, can unambiguously identify multiple zones associated with a transmission, such that wrap-around in adjacent zones based on zone ID alone will not prompt a receiving vehicle (e.g., a receiving UE or a receiving device) to report feedback to a transmitting vehicle (e.g., a transmitting UE or a transmitting device). The destination IDs may be selected from multiple sets of destination IDs, where different sets of IDs are partitioned to different super-zones.

A method for wireless communication at a transmitting device is described. The method may include identifying a zone ID associated with a sidelink transmission, determining a destination ID for the sidelink transmission based on a longitude and a latitude of the transmitting device, transmitting the sidelink transmission to one or more receiving devices, the sidelink transmission including control information that indicates the zone ID and the destination ID, and monitoring for one or more distance-based feedback messages from the one or more receiving devices.

An apparatus for wireless communication at a transmitting device is described. The apparatus may include a processor, memory coupled with the processor, and instructions stored in the memory. The instructions may be executable by the processor to cause the apparatus to identify a zone ID associated with a sidelink transmission, determine a destination ID for the sidelink transmission based on a longitude and a latitude of the transmitting device, transmit the sidelink transmission to one or more receiving devices, the sidelink transmission including control information that indicates the zone ID and the destination ID, and monitor for one or more distance-based feedback messages from the one or more receiving devices.

Another apparatus for wireless communication at a transmitting device is described. The apparatus may include means for identifying a zone ID associated with a sidelink transmission, means for determining a destination ID for the sidelink transmission based on a longitude and a latitude of the transmitting device, means for transmitting the sidelink transmission to one or more receiving devices, the sidelink transmission including control information that indicates the zone ID and the destination ID, and means for monitoring for one or more distance-based feedback messages from the one or more receiving devices.

A non-transitory computer-readable medium storing code for wireless communication at a transmitting device is described. The code may include instructions executable by a processor to identify a zone ID associated with a sidelink transmission, determine a destination ID for the sidelink transmission based on a longitude and a latitude of the transmitting device, transmit the sidelink transmission to one or more receiving devices, the sidelink transmission including control information that indicates the zone ID and the destination ID, and monitor for one or more distance-based feedback messages from the one or more receiving devices.

In some examples of the method, apparatuses, and non-transitory computer-readable medium described herein, the determining the destination ID may include operations, features, means, or instructions for determining a geographical longitude and a geographical latitude of the transmitting device and determining a subset of bits of the destination ID based on the geographical longitude and the geographical latitude of the transmitting device.

In some examples of the method, apparatuses, and non-transitory computer-readable medium described herein, an application layer selects the destination ID from a range of available destination IDs for indicating a super-zone location of the transmitting device.

In some examples of the method, apparatuses, and non-transitory computer-readable medium described herein, a super-zone includes a union of a set of adjacent zones, each zone a square determined by latitude and longitude.

In some examples of the method, apparatuses, and non-transitory computer-readable medium described herein, the destination ID indicates the super-zone location of the transmitting device in a subset of bits associated with a geographical longitude and a geographical latitude of the transmitting device.

In some examples of the method, apparatuses, and non-transitory computer-readable medium described herein, the subset of bits includes four or five bits that provide an indication of the geographical longitude of the transmitting device and four or five bits that provide an indication of the geographical latitude of the transmitting device.

In some examples of the method, apparatuses, and non-transitory computer-readable medium described herein, location information associated with the destination ID indicates that a first receiving device of the one or more receiving devices having a location in an adjacent super-zone or a same super-zone associated with the zone ID may be to provide distance-based feedback messages.

In some examples of the method, apparatuses, and non-transitory computer-readable medium described herein, a single zone size may be associated with the zone ID and the destination ID.

In some examples of the method, apparatuses, and non-transitory computer-readable medium described herein, two or more different zone sizes may be associated with the destination ID and different ranges of destination ID values may be associated with different zone sizes.

In some examples of the method, apparatuses, and non-transitory computer-readable medium described herein, the different ranges of destination ID values associated with different zone sizes may be non-overlapping.

A method for wireless communication at a receiving device is described. The method may include receiving, from a transmitting device, a SCI transmission that includes a zone ID, a destination ID, and an indication of an associated sidelink shared channel transmission, determining, based on a geographical location of the receiving device, the zone ID, and location information associated with the destination ID, to decode the associated sidelink shared channel transmission, and transmitting a distance-based feedback message to the transmitting device responsive to unsuccessful decoding of the associated sidelink shared channel transmission.

An apparatus for wireless communication at a receiving device is described. The apparatus may include a processor, memory coupled with the processor, and instructions stored in the memory. The instructions may be executable by the processor to cause the apparatus to receive, from a transmitting device, a SCI transmission that includes a zone ID, a destination ID, and an indication of an associated sidelink shared channel transmission, determine, based on a geographical location of the receiving device, the zone ID, and location information associated with the destination ID, to decode the associated sidelink shared channel transmission, and transmit a distance-based feedback message to the transmitting device responsive to unsuccessful decoding of the associated sidelink shared channel transmission.

Another apparatus for wireless communication at a receiving device is described. The apparatus may include means for receiving, from a transmitting device, a SCI transmission that includes a zone ID, a destination ID, and an indication of an associated sidelink shared channel transmission, means for determining, based on a geographical location of the receiving device, the zone ID, and location information associated with the destination ID, to decode the associated sidelink shared channel transmission, and means for transmitting a distance-based feedback message to the transmitting device responsive to unsuccessful decoding of the associated sidelink shared channel transmission.

A non-transitory computer-readable medium storing code for wireless communication at a receiving device is described. The code may include instructions executable by a processor to receive, from a transmitting device, a SCI transmission that includes a zone ID, a destination ID, and an indication of an associated sidelink shared channel transmission, determine, based on a geographical location of the receiving device, the zone ID, and location information associated with the destination ID, to decode the associated sidelink shared channel transmission, and transmit a distance-based feedback message to the transmitting device responsive to unsuccessful decoding of the associated sidelink shared channel transmission.

In some examples of the method, apparatuses, and non-transitory computer-readable medium described herein, the determining may include operations, features, means, or instructions for determining that the transmitting device may be within a same set of zones or an adjacent set of zones as the receiving device, based on the location information associated with the destination ID, a geographic longitude of the receiving device, and a geographic latitude of the receiving device, where the zone ID indicates a location of the transmitting device within a set of zones that may be addressable by the zone ID.

In some examples of the method, apparatuses, and non-transitory computer-readable medium described herein, a set of destination IDs may be indicated at an application layer of the receiving device that may be associated with the set of zones and adjacent set of zones, and a distance between the receiving device and the transmitting device may be determined at a layer of the receiving device that may be lower than the application layer.

In some examples of the method, apparatuses, and non-transitory computer-readable medium described herein, the destination ID includes a set of bits and indicates the set of zones and adjacent set of zones associated with the transmitting device in a subset of the set of bits, the subset of bits associated with a geographical longitude and a geographical latitude of the transmitting device.

In some examples of the method, apparatuses, and non-transitory computer-readable medium described herein, the determining may include operations, features, means, or instructions for determining, based on the destination ID, a quadrant of a set of zones associated with the transmitting device, where the zone ID indicates a location of the transmitting device within the set of zones that may be addressable by the zone ID and determining that the receiving device may be located in the set of zones or in a different set zones that may be adjacent to the quadrant of the set of zones associated with the transmitting device.

In some examples of the method, apparatuses, and non-transitory computer-readable medium described herein, the determining may include operations, features, means, or instructions for determining that the distance-based feedback message may be to be provided based on the receiving device being located in the set of zones or in the different set zones that may be adjacent to the quadrant of the set of zones associated with the transmitting device.

### BRIEF DESCRIPTION OF THE DRAWINGS

FIG. 1 illustrates an example of a wireless communications system that supports techniques for distance based feedback for device-to-device communications in accordance with one or more aspects of the present disclosure.

FIG. 2 illustrates an example of a wireless communications system that supports techniques for distance based feedback for device-to-device communications in accordance with one or more aspects of the present disclosure.

FIG. 3 illustrates an example of a zone diagram that supports techniques for distance based feedback for device-to-device communications in accordance with one or more aspects of the present disclosure.

FIG. 4 illustrates an example of a zone diagram that supports techniques for distance based feedback for device-to-device communications in accordance with one or more aspects of the present disclosure.

FIG. 5 illustrates an example of a process flow that supports techniques for distance based feedback for device-to-device communications in accordance with one or more aspects of the present disclosure.

FIGS. 6 and 7 illustrate block diagrams of devices that support techniques for distance based feedback for device-to-device communications in accordance with one or more aspects of the present disclosure.

FIG. 8 illustrates a block diagram of a communications manager that supports techniques for distance based feedback for device-to-device communications in accordance with one or more aspects of the present disclosure.

FIG. 9 illustrates a diagram of a system including a device that supports techniques for distance based feedback for device-to-device communications in accordance with one or more aspects of the present disclosure.

FIGS. 10 through 12 illustrate flowcharts showing methods that support techniques for distance based feedback for device-to-device communications in accordance with one or more aspects of the present disclosure.

### DETAILED DESCRIPTION

Some vehicles may be equipped with on-board transceivers to enable wireless communications with other vehicles or devices. Such wireless communications may include, for example, communication of vehicle-to-everything (V2X) signals. In V2X communications, vehicles may send groupcast messages that are intended for vehicles within a proximity to the transmitting vehicle. The groupcast messages may include a control portion (e.g., a sidelink control information (SCI)-1 or SCI-2) and a data portion. If a receiving vehicle receives the control portion but not the data portion, the receiving vehicle may send a negative acknowledgment (NACK) back to the transmitting vehicle to initiate retransmission. If a receiving vehicle receives both the control portion and data portion no feedback may be transmitted. In some examples, proximity information may be provided through an indication of a zone identifier (ID) of the transmitting vehicle, which may be a 12-bit value with 6-bits that indicate the X-direction and 6-bits that indicate the Y-direction. Such a design for indicating proximity information results in zone-IDs that wrap around every 2⁶n meters where n is the resolution size (e.g., with a 20 meter X/Y resolution, wrap-around occurs every 1280 meters in the X and Y directions). Such a distance usually results in sufficient separation of zones with the same zone ID to prevent reception of irrelevant signals. However, in some corner cases (e.g., in a sparsely occupied highway, or in urban settings where non-line of sight (NLOS) is prevalent) a vehicle (e.g., a user equipment (UE)) may receive unintended SCI with a duplicate zone ID and may fail to receive the PSSCH, resulting in a NACK transmission and an associated retransmission. Such a NACK transmission and associated retransmissions for unintended SCIs may have a negative impact on network efficiency and may increases interference due to additional transmissions.

Aspects of the present disclosure relate to techniques that resolve such zone ID ambiguity while also being compatible with the 12-bit zone ID scheme. For example, application layer procedures may provide for selection of a destination ID for V2X transmissions that indicates a super-zone. The super-zone, combined with the existing zone ID, can unambiguously identify multiple zones associated with a transmission, such that wrap-around in adjacent zones based on zone ID alone will not prompt a receiving vehicle (e.g., a receiving UE or a receiving device) to report feedback to a transmitting vehicle (e.g., a transmitting UE or a transmitting device). The destination IDs may be selected from multiple sets of destination IDs, where different sets of IDs are partitioned to different super-zones. In some cases, a 16 bit destination ID may have 4 or 5 bits that correspond to longitude, and 4 or 5 bits that correspond to latitude. The latitude/longitude for the destination ID may be determined by the UE's geographical longitude/latitude (GLL). The application layer may instruct UE to receive a PSSCH transmission from either the same super-zone, or neighbor super-zones only.

Aspects of the disclosure are initially described in the context of wireless communications systems. Aspects of the disclosure are further illustrated by and described with reference to zone diagrams, process flows, apparatus diagrams, system diagrams, and flowcharts that relate to techniques for distance based feedback for device-to-device communications.

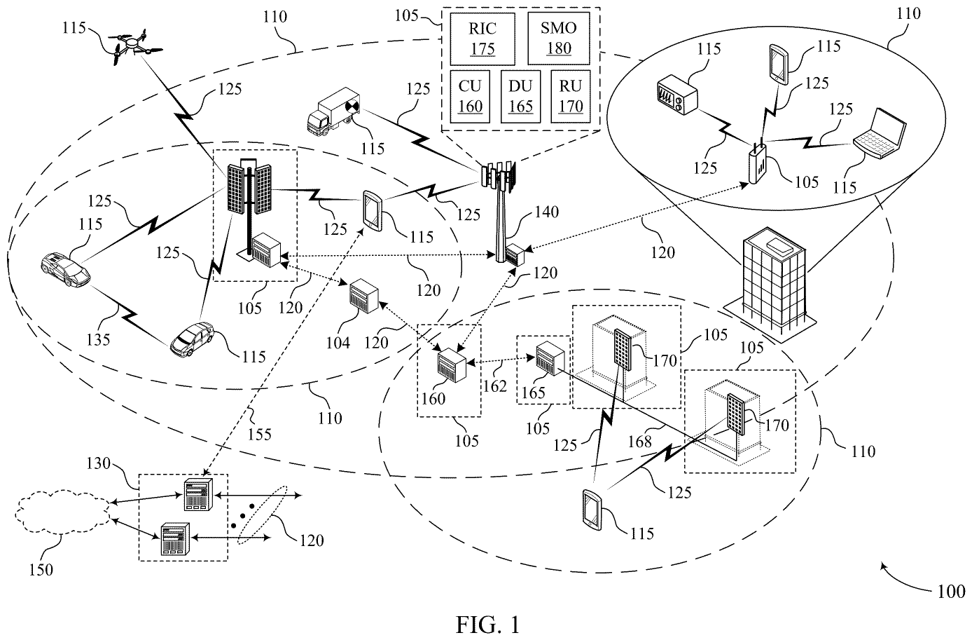

FIG. 1 illustrates an example of a wireless communications system 100 that supports techniques for distance based feedback for device-to-device communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architect ure may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for distance based feedback for device-to-device communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(λfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the wireless communications system 100 may implement V2X communications. For example, V2X communications may be used for transmission of safety messages for autonomous or manually driven vehicles. For example, V2X may be used to share sensor or location data with other vehicles or with infrastructure, which may allow for predictable and coordinated autonomous driving.

In V2X communications, vehicles (e.g., UEs 115) may send groupcast messages that are intended for vehicles (e.g., other UEs 115) within a proximity to the transmitting vehicle. The groupcast messages may include a control portion (e.g., an SCI-1 or SCI-2) and a data portion. If a receiving vehicle receives the control portion but not the data portion, the receiving vehicle may send a NACK back to the transmitting vehicle to initiate retransmission. If a receiving vehicle receives both the control portion and data portion no feedback may be transmitted. In some examples, proximity information is provided through an indication of a zone ID of the transmitting vehicle, which may be a 12-bit value with 6-bits that indicate the X-direction and 6-bits that indicate the Y-direction. Such a design for indicating proximity information results in zone-IDs that wrap around every 2⁶n meters where n is the resolution size (e.g., with a 20 meter X/Y resolution, wrap-around occurs every 1280 meters in the X and Y directions). Such a distance usually results in sufficient separation of zones with the same zone ID to prevent reception of irrelevant signals. However, in some corner cases (e.g., in a sparsely occupied highway, or in urban settings where non-LOS is prevalent) a vehicle may receive unintended SCI with a duplicate zone ID and may fail to receive the PSSCH, resulting in a NACK transmission and an associated retransmission. Such a NACK transmission and associated retransmissions for unintended SCIs may have a negative impact on network efficiency and may increases interference due to additional transmissions.

Aspects of the present disclosure relate to techniques that resolve such zone ID ambiguity while also being compatible with the 12-bit zone ID scheme. For example, application layer procedures may provide selection of a destination ID for V2X transmissions that indicates a super-zone. The super-zone, combined with the existing zone ID, can unambiguously identify multiple zones associated with a transmission, such that wrap-around in adjacent zones based on zone ID alone will not prompt a receiving vehicle (e.g., a receiving UE 115 or a receiving device) to report feedback to a transmitting vehicle (e.g., a transmitting UE 115 or a transmitting device). The destination IDs may be selected from multiple sets of destination IDs, where different sets of IDs are partitioned to different super-zones. In some cases, a 16 bit destination ID may have 4 or 5 bits that correspond to longitude, and 4 or 5 bits that correspond to latitude. The latitude/longitude for the destination ID may be determined by the UE 115's GLL. The application layer may instruct UE 115 to receive PSSCH from either the same super-zone, or neighbor super-zones only.

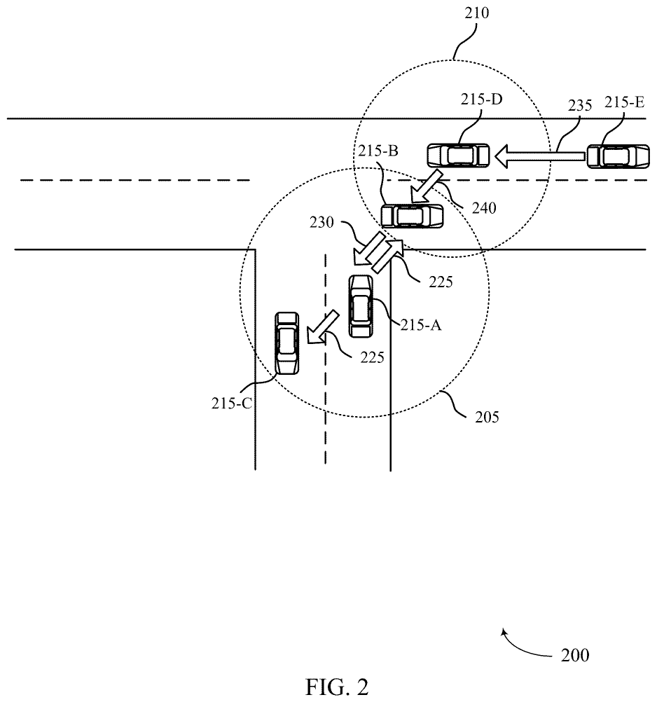

FIG. 2 illustrates an example of a wireless communications system 200 that supports techniques for distance based feedback for device-to-device communications in accordance with one or more aspects of the present disclosure. In some examples, the wireless communications system 200 may implement aspects of wireless communications system 100. Wireless communications system 200 may include a UE 215-a, a UE 215-b, a UE 215-c, a UE 215-d, and a UE 215-e, which may be examples UEs 115 as described herein with reference to FIG. 1. For example, the UE 215-a, the UE 215-b, the UE 215-c, the UE 215-b, and/or the UE 215-e may be vehicles.

The wireless communications system 200 may implement V2X communications, which may include application-aware, distance based multicast communications. Application-specific distance may be based on relevancy. For example, a transmitting UE (e.g., the UE 215-a) may adapt transmission to relevant vehicles (e.g., UEs 215) within range of the transmitting UE, and the receiving vehicles may acknowledge relevant messages and disregard irrelevant messages. For example, the UE 215-a may have an application specific distance 205, and the UE 215-d may have an application specific distance 210. Application specific distances may be used, for example, because V2X messages may be irrelevant for UEs outside of the given application specific distance. For example, information sensed by the UE 215-a (e.g., a sensed obstacle) may be irrelevant to UEs a given distance away from the UE 215-a.

For example, a minimum communication range (MCR) may be defined, which may define a range of the application specific distance. Accordingly, the application specific distance for any UE may be indicated by a zone ID for the transmitting UE (e.g., the UE 215-a) and the minimum communication range. The MCR may be a range, for example, of a set of 20 meters, 50 meters, 80 meters, 100 meters, 120 meters, 150 meters, 180 meters, 200 meters, 220 meters, 250 meters, 270 meters, 300 meters, 350 meters, 370 meters, 420 meters, 450 meters, 480 meters, 500 meters, 550 meters, 600 meters, 700 meters, or 1000 meters, and up to 8 spare values may be indicated. An application-dependent MCR may be indicated in SCI-2 as an index into a 16-value subset of the set of 20 meters, 50 meters, 80 meters, 100 meters, 120 meters, 150 meters, 180 meters, 200 meters, 220 meters, 250 meters, 270 meters, 300 meters, 350 meters, 370 meters, 420 meters, 450 meters, 480 meters, 500 meters, 550 meters, 600 meters, 700 meters, or 1000 meters, and up to 8 spare values.

The UE 215-a may transmit a groupcast sidelink message 225, which may indicate a zone ID of the UE 215-a and the application specific distance 205 (e.g., the MCR). A control portion (e.g., an SCI-2) of the groupcast sidelink message 225 may indicate the zone ID and the MCR corresponding to the application specific distance 205. Zones may be squares with dimensions (pre)configured from 5 meters, 10 meters, 20 meters, 40 meters, or 50 meters. The zone ID of the transmitting UE (e.g., the UE 215-a) may be determined from the GLL of the transmitting UE. An SCI-2 may include 12 bits to indicate the zone ID, which may be represent the least significant bit (LSB) of a sampled UE location/GLL.

An SCI-2 may be used for decoding physical sidelink shared channel (PSSCH), with HARQ operation when HARQ includes NACK only or when HARQ information is not fed back. An SCI-2 may include: 4 bits indicating a HARQ process number; 1 bit indicating a new data indicator (NDI); 2 bits indicating a redundancy version (RV); 8 bits indicating the source ID; 16 bits indicating a destination ID; 1 bit indicating whether HARQ feedback is enabled or disabled; 12 bits indicating the zone ID as described herein; and 4 bits indicating the communication range requirement, which may be determined by a higher layer parameter sl-ZoneConfigMCR-Index.

The UE 215-b and the UE 215-c are within the application specific distance 205, and accordingly the UE 215-b and the UE 215-c attempt to decode the data portion of the groupcast sidelink message 225. For example, the transmit-receive distance between the transmitting UE and the receiving UE may be computed based on the transmitting UE zone ID and the location of the receiving UE. The UE 215-c may successfully decode the data portion of the groupcast sidelink message 225, and accordingly may refrain from sending a NACK for the groupcast sidelink message 225. The UE 215-b may not successfully decode the groupcast sidelink message 225, and accordingly may transmit a NACK 230 to the UE 215-a. In response to receiving the NACK 230, the UE 215-a may retransmit the groupcast sidelink message 225.

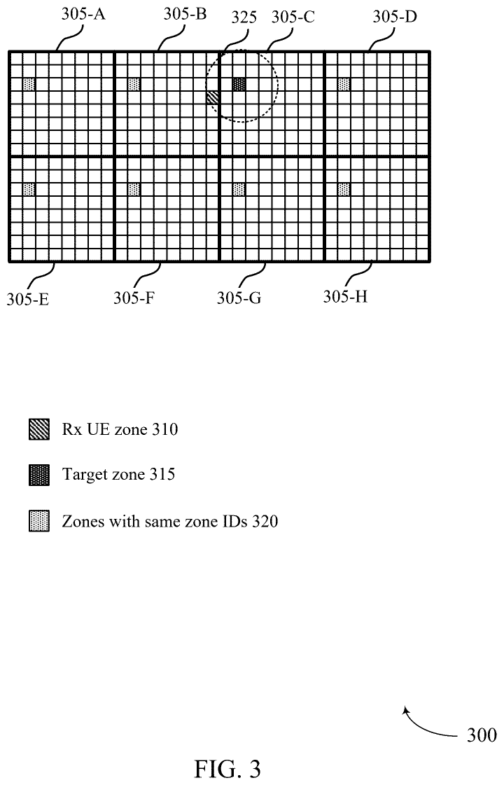

As described with reference to FIG. 3, zone IDs may be indicated via a 12-bit value with 6-bits that indicate the X-direction and 6-bits that indicate the Y-direction, which results in zone-IDs that wrap around every 2⁶n meters where n is the resolution size. Due to wrap-around, the UE 215-e may interpret itself as being in a zone indicated in the application specific distance 205 of the UE 215-a indicated by the zone ID specified in the SCI-2 of the groupcast sidelink message 225. If the UE 215-e fails to successfully decode the data portion of the groupcast sidelink message 225, the UE 215-e may send a NACK 235. The NACK and/or an accompanying retransmission of the groupcast sidelink message 225 may increase interference 240 within the wireless communications system 200.

Accordingly, as described herein, the groupcast sidelink message 225 (e.g., the control portion of the groupcast sidelink message 225 such as an SCI-2) may include a destination ID that indicates a super-zone. The super-zone identified by the destination ID, combined with the zone IDs, may unambiguously identify multiple zones associated with a groupcast sidelink message 225, such that wrap-around in adjacent zones based on zone ID alone will not prompt a receiving vehicle (e.g., the UE 215-e) to report feedback. Accordingly, inclusion of a destination ID that indicates a super-zone may decrease interference 240 within the wireless communications system 200.

FIG. 3 illustrates an example of a zone diagram 300 that supports techniques for distance based feedback for device-to-device communications in accordance with one or more aspects of the present disclosure. In some examples, the zone diagram 300 may implement or may be implemented by aspects of wireless communications system 100 or the wireless communications system 200.

As described herein, a transmitting UE (e.g., the UE 215-a of FIG. 2) may indicate in SCI-2 of a groupcast sidelink transmission (e.g., the groupcast sidelink message 225 of FIG. 2) the zone ID for the transmitting UE and an MCR. The zone ID may be indicated by a 12-bit value with 6-bits that indicate the X-direction and 6-bits that indicate the Y-direction. Accordingly, zones IDs wrap around every 2⁶n meters where n is the resolution size in meters. Thus 64 zones in each direction may occur before another zone has the same zone ID. As shown, zones 320 within a same position within a indexed set of zones (e.g., the indexed set of zones 305-a, the indexed set of zones 305-b, the indexed set of zones 305-c, the indexed set of zones 305-d, the indexed set of zones 305-e, the indexed set of zones 305-f, the indexed set of zones 305-g, and the indexed set of zones 305-h) have the same zone ID. While each indexed set of zones is shown in FIG. 3 as 8 zones by 8 zones for illustrative purposes, a indexed set of zones where 12 bits are used to indicate each zone would be 64 zones by 64 zones.

The further away a receiving UE is from the transmitting UE, the less likely the receiving UE is to be able to successfully decode a sidelink transmission, and accordingly the more likely the receiving UE is to transmit a NACK. The control portion of a sidelink transmission, however, may be decoded even after several wrap around cycles. A UE in a zone with the same zone ID as the target receiver may inadvertently determine that the UE is a targeted receiver.

For example, to reach a target at 80 meters non-LOS (e.g., in a crossing road), a zone size of 20 meters may be used. Accordingly, wrap around would occur at 2⁶(20)=1280 meters. In a free space condition, a link budget of control may be up to 2000 meters, and in such examples, at least one zone confusion may occur. For example, a UE in the zone 310 may receive a sidelink transmission from a UE in the zone 315, and the UE in the zone 310 may be inside an indicated MCR 325 for the sidelink transmission from the UE in the zone 315. The zone 315 has a same zone ID as the zones 320 based on wrap around. Accordingly, a UE in the zone 310 may attempt to decode and transmit feedback for sidelink messages transmitted by UEs in the zones 320 even if outside of the intended MCR for sidelink messages transmitted by UEs in the zones 320. As the UE in the zone 310 is farther away from the zones 320, the probability of successfully decoding the sidelink transmissions from the UEs in the zones 320 is small, and thus the UE in the zone 310 is likely to transmit a NACK, which may result in an unnecessary retransmission of the sidelink message. Such NACKs and unnecessary retransmission caused by unintended recipient UEs may lead to interference.

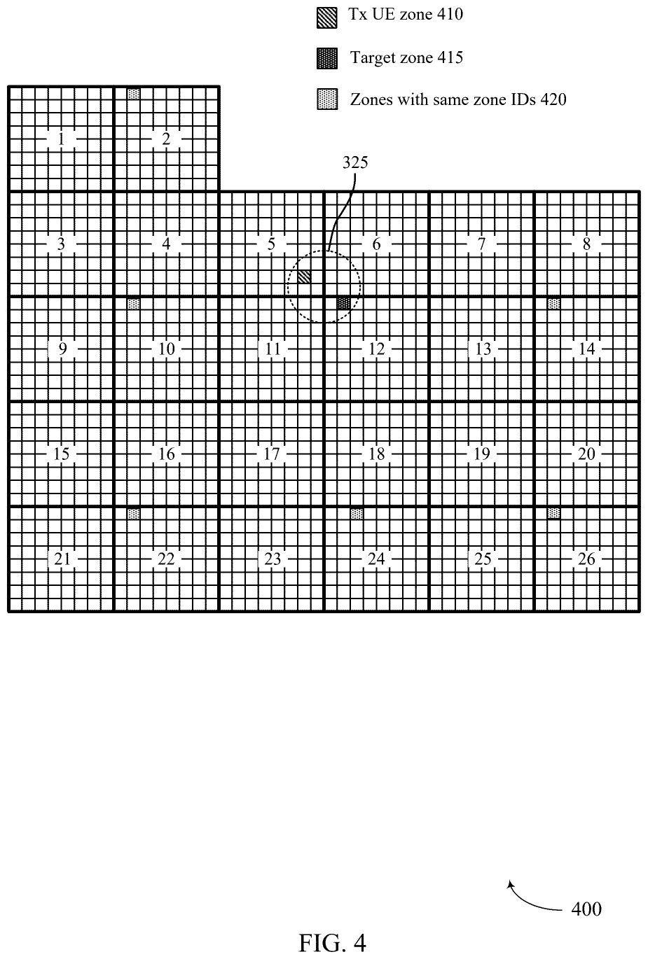

FIG. 4 illustrates an example of a zone diagram 400 that supports techniques for distance based feedback for device-to-device communications in accordance with one or more aspects of the present disclosure. In some examples, the zone diagram 400 may implement or may be implemented by aspects of wireless communications system 100 or the wireless communications system 200.

The source ID, destination ID, and zone ID may be used to pre-filter PSSCH before triggering physical sidelink feedback channel (PSFCH) transmission for a PSSCH. For example, a transmitting UE (e.g., the UE 215-a of FIG. 2) may set the destination ID following an application instruction, and the application may select the destination IDs from a range of available application IDs.

As described herein, a transmitting UE (e.g., the UE 215-a of FIG. 2) may indicate in SCI-2 of a groupcast sidelink transmission (e.g., the groupcast sidelink message 225 of FIG. 2) the zone ID for the transmitting UE and an MCR. The zone ID may be indicated by a 12-bit value with 6-bits that indicate the X-direction and 6-bits that indicate the Y-direction. Accordingly, zones IDs wrap around every 2⁶n meters where n is the resolution size in meters. Thus 64 zones in each direction may occur before another zone has the same zone ID. Assuming a single value for zone size, and an MCR is less than a zone size*16, then the application layer may have a notion of super-zones. Super-zones may be determined with reference to UE GLL.

In some examples, the super-zone size may be the zone size*32. In some examples, the super-zone ID may be 8 or 10 bits (e.g., corresponding to 4/5 bits in longitude and 4/5 bits in latitude). Thus, a wrap around size would be 5120 meters (e.g., for a 5 meter zone size with 10 bit ID for a super-zone or a 10 meter zone size with 8 bit ID for a super-zone), which is beyond the pathloss conditions for most scenarios. An application may instruct a receiving UE to receive PSSCH from either the same super-zone or neighboring super-zones, and to not receive PSSCH from other super-zones.

The list of received super-zones may depend on the actual device location and the target communication range.

For example, FIG. 4 illustrates 26 super-zones. A receiving UE in super-zone 12 (e.g., in the zone 410) may only attempt to receive PSSCH from and transmit PSFCH for transmitting UEs located in super-zones 5, 6, 11, and 12 (e.g., the neighboring super-zones and the same super-zone). As shown, the same zone IDs 420 occur only in super-zones that are not neighbors to a target zone 415. For example, for the target zone 415, the zones with the same zone-IDs are located in super-zones 2, 10, 14, 22, 24, and 26. Receiving UEs at the zone ID 420 in super-zone 2, would only attempt to receive and transmit PSFCH for transmitting UEs in super-zone 1; receiving UEs at the zone ID 420 in super-zone 10, would only attempt to receive and transmit PSFCH for transmitting UEs in super-zones 2, 4, 9, and 10; receiving UEs at the zone ID 420 in super-zone 14, would only attempt to receive and transmit PSFCH for transmitting UEs in super-zones 7, 8, 13, and 14; receiving UEs at the zone ID 420 in super-zone 22, would only attempt to receive and transmit PSFCH for transmitting UEs in super-zones 15, 16, 21, and 22; receiving UEs at the zone ID 420 in super-zone 24, would only attempt to receive and transmit PSFCH for transmitting UEs in super-zones 17, 18, 23, and 24; and receiving UEs at the zone ID 420 in super-zone 26, would only attempt to receive and transmit PSFCH for transmitting UEs in super-zones 19, 20, 25, and 26. Accordingly, for a receiving UE in the target zone 415 in the super-zone 12 there is no zone confusion due to wrap around since the receiving UE in the target zone 415 in the super-zone 12 would attempt to receive a PSSCH from a UE in zone 410 in super-zone 5 (or super-zones 6, 11, or 12). The application layer may provision different destination ID ranges for different zone size values, and the ranges for different zone sizes may be non-overlapping.

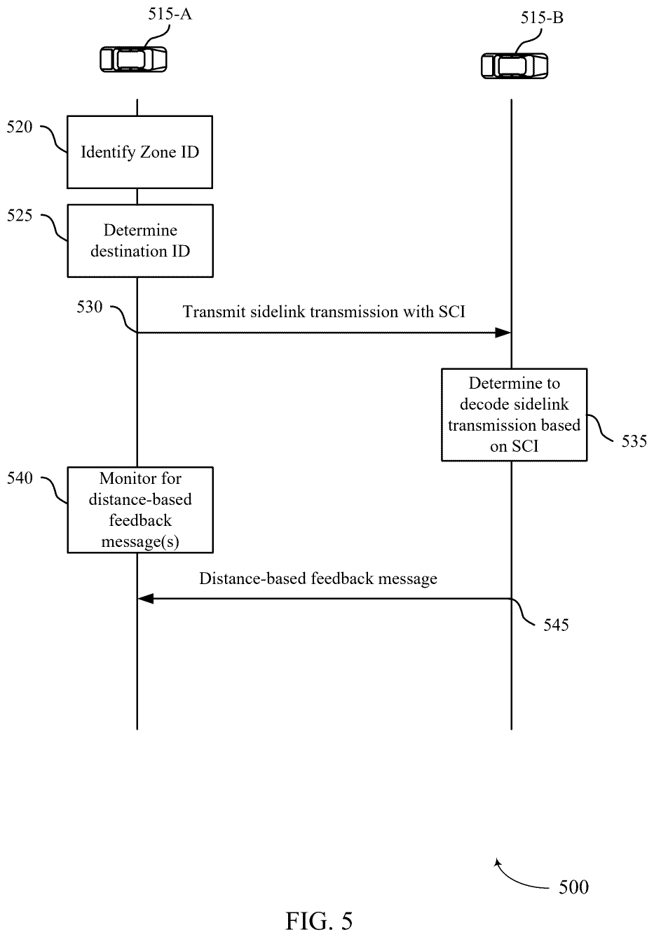

FIG. 5 illustrates an example of a process flow 500 that supports techniques for distance based feedback for device-to-device communications in accordance with one or more aspects of the present disclosure. The process flow 500 may include a first UE 515-a and a second UE 515-b, which may be an example of UEs 115 or UEs 215 as described with reference to FIG. 1 and FIG. 2, respectively. In the following description of the process flow 500, the operations between the first UE 515-a and the second UE 515-b may be transmitted in a different order than the example order shown, or the operations performed by the first UE 515-a and the second UE 515-b may be performed in different orders or at different times. Some operations may also be omitted from the process flow 500, and other operations may be added to the process flow 500.

At 520, the first UE 515-a may identify a zone ID associated with a sidelink transmission (e.g., based on the zone ID corresponding to the GLL of the first UE 515-a). At 525, the first UE 515-a may identify a destination ID for the sidelink transmission based on a longitude and a latitude of the first UE 515-a.

In some examples, determining the destination ID includes determining a geographical longitude and a geographical latitude of the first UE 515-a and determining a subset of bits of the destination ID based on the geographical longitude and the geographical latitude of the first UE 515-a.

In some examples, an application layer selects the destination ID from a range of available destination IDs for indicating a super-zone location of the first UE 515-a. In some examples, a super-zone includes a union of a set of adjacent zones, each zone a square determined by latitude and longitude. In some examples, the destination ID indicates the super-zone location of the first UE 515-a in a subset of bits associated with a geographical longitude and a geographical latitude of the first UE 515-a. In some examples, the subset of bits include four or five bits that provide an indication of the geographical longitude of the first UE 515-a and four or five bits that provide an indication of the geographical latitude of the first UE 515-a.

In some examples, location information associated with the destination ID indicates that a first receiving device of the one or more receiving devices has a location in an adjacent super-zone or a same super-zone associated with the zone ID is to provide distance-based feedback messages.

In some examples, a single zone size is associated with the zone ID and the destination ID.

In some examples, two or more different zone sizes are associated with the destination ID, and different ranges of destination ID values are associated with different zone sizes. In some examples, the different ranges of destination ID values associated with different zone sizes are non-overlapping.

At 530, the first UE 515-a may transmit the sidelink transmission to one or more receiving devices, including the second UE 515-b, the sidelink transmission including control information that indicates the zone ID and the destination ID. For example, at 530, the second UE 515-b may receive an SCI that includes the zone ID and the destination ID as well as an indication of an associated sidelink shared channel transmission. For example, the control information may be included in the SCI.

At 535, the second UE 515-b may determine, based on geographical location of the second UE 515-b, the zone ID, and location information associated with the destination ID, to decode the associated sidelink shared channel transmission.

In some examples, determining to decode the associated sidelink shared channel transmission may include determining that the first UE 515-a is within a same set of zones or an adjacent set of zones as the second UE 515-b, based on the location information associated with the destination ID, a geographic longitude of the second UE 515-b, and a geographic latitude of the second UE 515-b, where the zone ID indicates a location of the first UE 515-a within a set of zones that are addressable by the zone ID. In some examples, a set of destination IDs are indicated at an application layer of the second UE 515-b that are associated with the set of zones and adjacent set of zones, and a distance between the second UE 515-b and the first UE 515-a is determined at a layer of the second UE 515-b that is lower than the application layer. In some examples, the destination ID includes a set of bits and indicates the set of zones and adjacent set of zones associated with the first UE 515-a in a subset of the set of bits, the subset of bits associated with a geographical longitude and a geographical latitude of the first UE 515-a.

In some examples, determining to decode the associated sidelink shared channel transmission may include: determining, based on the destination ID, a quadrant of a set of zones associated with the first UE 515-a, where the zone ID indicates a location of the first UE 515-a within the set of zones that are addressable by the zone ID; and determining that the second UE 515-b is located in the set of zones or in a different set zones that is adjacent to the quadrant of the set of zones associated with the first UE 515-a. In some examples, determining to decode the associated sidelink shared channel transmission may include determining that the distance-based feedback message is to be provided based on the second UE 515-b being located in the set of zones or in the different set zones that is adjacent to the quadrant of the set of zones associated with the first UE 515-a.

At 540, the first UE 515-a may monitor for one or more distance-based feedback messages from the one or more receiving devices, including the second UE 515-b. Distance-based feedback messages transmitted by the one or more receiving devices, including the second UE 515-b, may be identical and may be transmitted in a single frequency network manner.

At 545, the second UE 515-b may transmit a distance-based feedback message to the first UE 515-a responsive to unsuccessful decoding of the associated sidelink shared channel transmission.

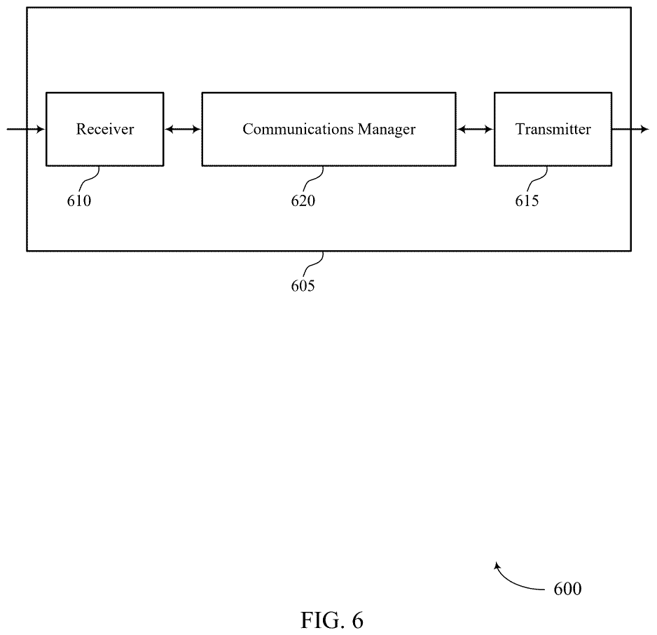

FIG. 6 illustrates a block diagram 600 of a device 605 that supports techniques for distance based feedback for device-to-device communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for distance based feedback for device-to-device communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for distance based feedback for device-to-device communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for distance based feedback for device-to-device communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a transmitting device in accordance with examples as disclosed herein. For example, the communications manager 620 may be configured as or otherwise support a means for identifying a zone ID associated with a sidelink transmission. The communications manager 620 may be configured as or otherwise support a means for determining a destination ID for the sidelink transmission based on a longitude and a latitude of the transmitting device. The communications manager 620 may be configured as or otherwise support a means for transmitting the sidelink transmission to one or more receiving devices, the sidelink transmission including control information that indicates the zone ID and the destination ID. The communications manager 620 may be configured as or otherwise support a means for monitoring for one or more distance-based feedback messages from the one or more receiving devices.

Additionally, or alternatively, the communications manager 620 may support wireless communication at a receiving device in accordance with examples as disclosed herein. For example, the communications manager 620 may be configured as or otherwise support a means for receiving, from a transmitting device, an SCI transmission that includes a zone ID, a destination ID, and an indication of an associated sidelink shared channel transmission. The communications manager 620 may be configured as or otherwise support a means for determining, based on a geographical location of the receiving device, the zone ID, and location information associated with the destination ID, to decode the associated sidelink shared channel transmission. The communications manager 620 may be configured as or otherwise support a means for transmitting a distance-based feedback message to the transmitting device responsive to unsuccessful decoding of the associated sidelink shared channel transmission.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

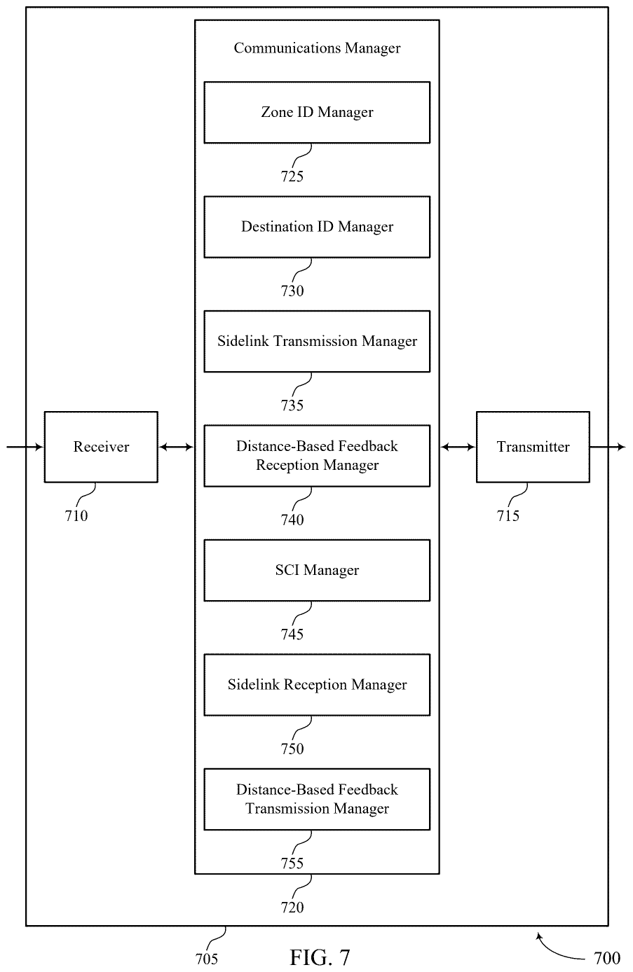

FIG. 7 illustrates a block diagram 700 of a device 705 that supports techniques for distance based feedback for device-to-device communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for distance based feedback for device-to-device communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for distance based feedback for device-to-device communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for distance based feedback for device-to-device communications as described herein. For example, the communications manager 720 may include a zone ID manager 725, a destination ID manager 730, a sidelink transmission manager 735, a distance-based feedback reception manager 740, an SCI manager 745, a sidelink reception manager 750, a distance-based feedback transmission manager 755, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a transmitting device in accordance with examples as disclosed herein. The zone ID manager 725 may be configured as or otherwise support a means for identifying a zone ID associated with a sidelink transmission. The destination ID manager 730 may be configured as or otherwise support a means for determining a destination ID for the sidelink transmission based on a longitude and a latitude of the transmitting device. The sidelink transmission manager 735 may be configured as or otherwise support a means for transmitting the sidelink transmission to one or more receiving devices, the sidelink transmission including control information that indicates the zone ID and the destination ID. The distance-based feedback reception manager 740 may be configured as or otherwise support a means for monitoring for one or more distance-based feedback messages from the one or more receiving devices.

Additionally, or alternatively, the communications manager 720 may support wireless communication at a receiving device in accordance with examples as disclosed herein. The SCI manager 745 may be configured as or otherwise support a means for receiving, from a transmitting device, an SCI transmission that includes a zone ID, a destination ID, and an indication of an associated sidelink shared channel transmission. The sidelink reception manager 750 may be configured as or otherwise support a means for determining, based on a geographical location of the receiving device, the zone ID, and location information associated with the destination ID, to decode the associated sidelink shared channel transmission. The distance-based feedback transmission manager 755 may be configured as or otherwise support a means for transmitting a distance-based feedback message to the transmitting device responsive to unsuccessful decoding of the associated sidelink shared channel transmission.

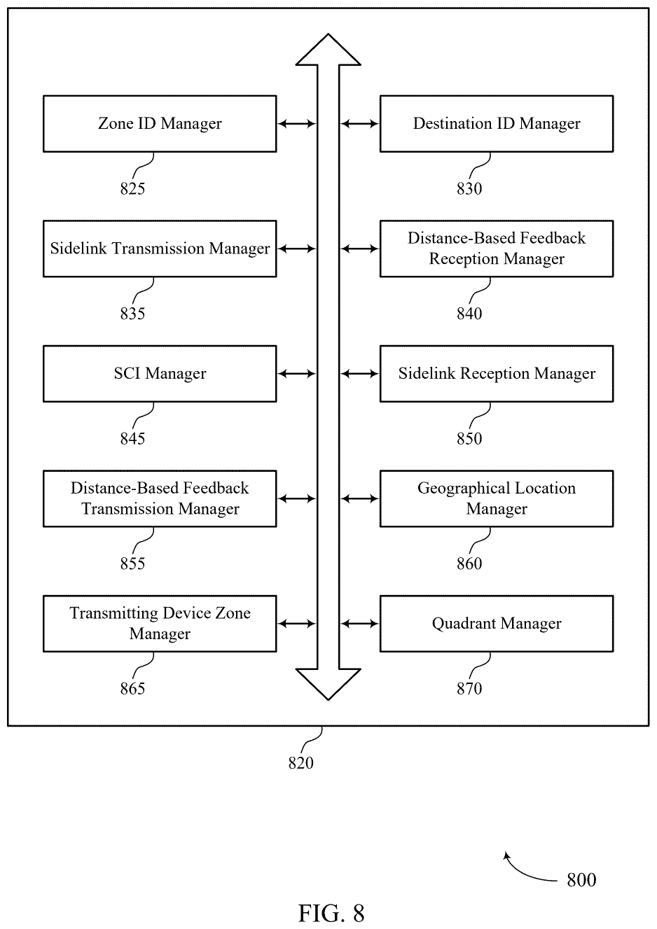

FIG. 8 illustrates a block diagram 800 of a communications manager 820 that supports techniques for distance based feedback for device-to-device communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for distance based feedback for device-to-device communications as described herein. For example, the communications manager 820 may include a zone ID manager 825, a destination ID manager 830, a sidelink transmission manager 835, a distance-based feedback reception manager 840, an SCI manager 845, a sidelink reception manager 850, a distance-based feedback transmission manager 855, a geographical location manager 860, a transmitting device zone manager 865, a quadrant manager 870, or any combination thereof. Each of these components may communicate, directly or indirectly, with one another (e.g., via one or more buses).

The communications manager 820 may support wireless communication at a transmitting device in accordance with examples as disclosed herein. The zone ID manager 825 may be configured as or otherwise support a means for identifying a zone ID associated with a sidelink transmission. The destination ID manager 830 may be configured as or otherwise support a means for determining a destination ID the sidelink transmission based on a longitude and a latitude of the transmitting device. The sidelink transmission manager 835 may be configured as or otherwise support a means for transmitting the sidelink transmission to one or more receiving devices, the sidelink transmission including control information that indicates the zone ID and the destination ID. The distance-based feedback reception manager 840 may be configured as or otherwise support a means for monitoring for one or more distance-based feedback messages from the one or more receiving devices.

In some examples, to support determining the destination ID, the geographical location manager 860 may be configured as or otherwise support a means for determining a geographical longitude and a geographical latitude of the transmitting device. In some examples, to support determining the destination ID, the destination ID manager 830 may be configured as or otherwise support a means for determining a subset of bits of the destination ID based on the geographical longitude and the geographical latitude of the transmitting device.

In some examples, an application layer selects the destination ID from a range of available destination IDs for indicating a super-zone location of the transmitting device.

In some examples, a super-zone includes a union of a set of adjacent zones, each zone a square determined by latitude and longitude.

In some examples, the destination ID indicates the super-zone location of the transmitting device in a subset of bits associated with a geographical longitude and a geographical latitude of the transmitting device.

In some examples, the subset of bits include four or five bits that provide an indication of the geographical longitude of the transmitting device and four or five bits that provide an indication of the geographical latitude of the transmitting device.

In some examples, location information associated with the destination ID indicates that a first receiving device of the one or more receiving devices having a location in an adjacent super-zone or a same super-zone associated with the zone ID is to provide distance-based feedback messages.

In some examples, a single zone size is associated with the zone ID and the destination ID.

In some examples, two or more different zone sizes are associated with the destination ID. In some examples, different ranges of destination ID values are associated with different zone sizes.

In some examples, the different ranges of destination ID values associated with different zone sizes are non-overlapping.

Additionally, or alternatively, the communications manager 820 may support wireless communication at a receiving device in accordance with examples as disclosed herein. The SCI manager 845 may be configured as or otherwise support a means for receiving, from a transmitting device, an SCI transmission that includes a zone ID, a destination ID, and an indication of an associated sidelink shared channel transmission. The sidelink reception manager 850 may be configured as or otherwise support a means for determining, based on a geographical location of the receiving device, the zone ID, and location information associated with the destination ID, to decode the associated sidelink shared channel transmission. The distance-based feedback transmission manager 855 may be configured as or otherwise support a means for transmitting a distance-based feedback message to the transmitting device responsive to unsuccessful decoding of the associated sidelink shared channel transmission.

In some examples, to support determining, the transmitting device zone manager 865 may be configured as or otherwise support a means for determining that the transmitting device is within a same set of zones or an adjacent set of zones as the receiving device, based on the location information associated with the destination ID, a geographic longitude of the receiving device, and a geographic latitude of the receiving device, where the zone ID indicates a location of the transmitting device within a set of zones that are addressable by the zone ID.

In some examples, a set of destination IDs are indicated at an application layer of the receiving device that are associated with the set of zones and adjacent set of zones, and a distance between the receiving device and the transmitting device is determined at a layer of the receiving device that is lower than the application layer.

In some examples, the destination ID includes a set of bits and indicates the set of zones and adjacent set of zones associated with the transmitting device in a subset of the set of bits, the subset of bits associated with a geographical longitude and a geographical latitude of the transmitting device.

In some examples, to support determining, the quadrant manager 870 may be configured as or otherwise support a means for determining, based on the destination ID, a quadrant of a set of zones associated with the transmitting device, where the zone ID indicates a location of the transmitting device within the set of zones that are addressable by the zone ID. In some examples, to support determining, the transmitting device zone manager 865 may be configured as or otherwise support a means for determining that the receiving device is located in the set of zones or in a different set zones that is adjacent to the quadrant of the set of zones associated with the transmitting device.

In some examples, to support determining, the transmitting device zone manager 865 may be configured as or otherwise support a means for determining that the distance-based feedback message is to be provided based on the receiving device being located in the set of zones or in the different set zones that is adjacent to the quadrant of the set of zones associated with the transmitting device.

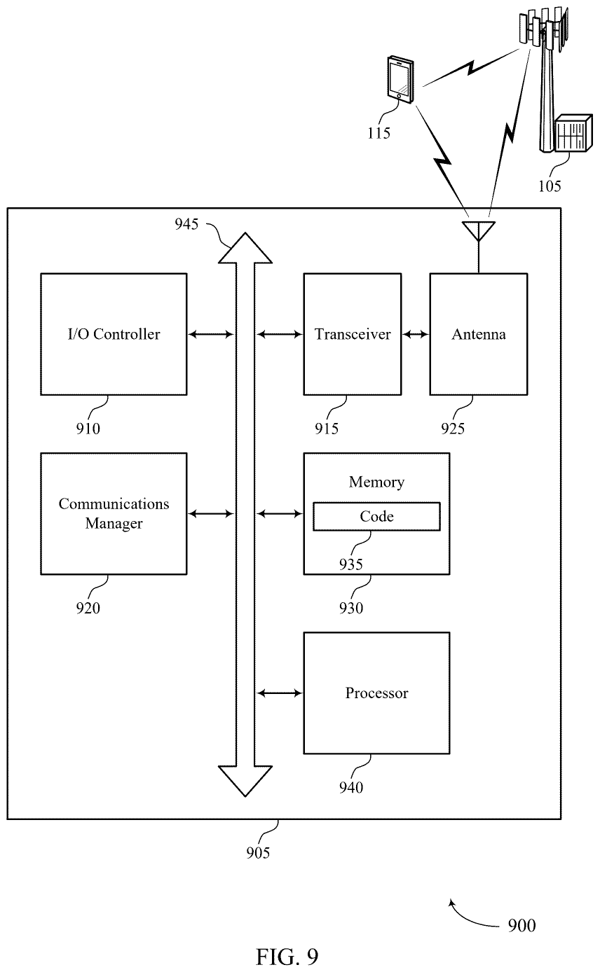

FIG. 9 illustrates a diagram of a system 900 including a device 905 that supports techniques for distance based feedback for device-to-device communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for distance based feedback for device-to-device communications). For example, the device 905 or a component of the device 905 may include a processor 940 and memory 930 coupled with or to the processor 940, the processor 940 and memory 930 configured to perform various functions described herein.

The communications manager 920 may support wireless communication at a transmitting device in accordance with examples as disclosed herein. For example, the communications manager 920 may be configured as or otherwise support a means for identifying a zone ID associated with a sidelink transmission. The communications manager 920 may be configured as or otherwise support a means for determining a destination ID for the sidelink transmission based on a longitude and a latitude of the transmitting device. The communications manager 920 may be configured as or otherwise support a means for transmitting the sidelink transmission to one or more receiving devices, the sidelink transmission including control information that indicates the zone ID and the destination ID. The communications manager 920 may be configured as or otherwise support a means for monitoring for one or more distance-based feedback messages from the one or more receiving devices.

Additionally, or alternatively, the communications manager 920 may support wireless communication at a receiving device in accordance with examples as disclosed herein. For example, the communications manager 920 may be configured as or otherwise support a means for receiving, from a transmitting device, an SCI transmission that includes a zone ID, a destination ID, and an indication of an associated sidelink shared channel transmission. The communications manager 920 may be configured as or otherwise support a means for determining, based on a geographical location of the receiving device, the zone ID, and location information associated with the destination ID, to decode the associated sidelink shared channel transmission. The communications manager 920 may be configured as or otherwise support a means for transmitting a distance-based feedback message to the transmitting device responsive to unsuccessful decoding of the associated sidelink shared channel transmission.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for distance based feedback for device-to-device communications as described herein, or the processor 940 and the memory 930 may be otherwise configured to perform or support such operations.

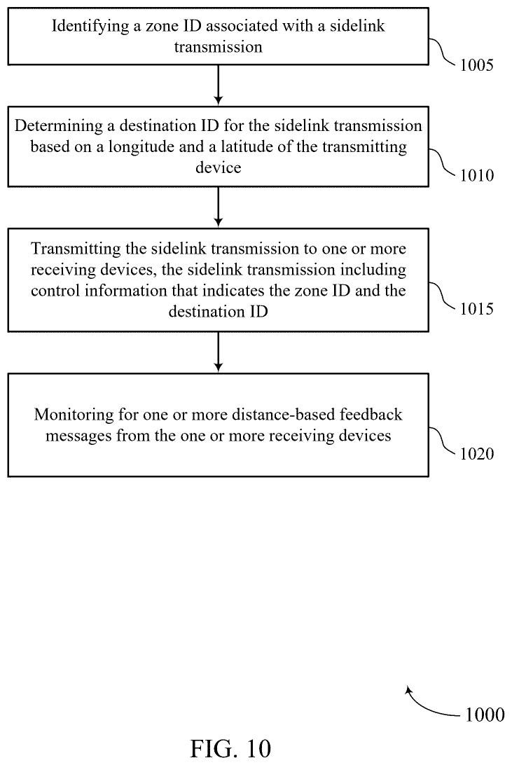

FIG. 10 illustrates a flowchart showing a method 1000 that supports techniques for distance based feedback for device-to-device communications in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include identifying a zone ID associated with a sidelink transmission. The operations of 1005 may be performed in accordance with examples as disclosed herein. In some examples, aspects of the operations of 1005 may be performed by a zone ID manager 825 as described with reference to FIG. 8.

At 1010, the method may include determining a destination ID for the sidelink transmission based on a longitude and a latitude of the transmitting device. The operations of 1010 may be performed in accordance with examples as disclosed herein. In some examples, aspects of the operations of 1010 may be performed by a destination ID manager 830 as described with reference to FIG. 8.

At 1015, the method may include transmitting the sidelink transmission to one or more receiving devices, the sidelink transmission including control information that indicates the zone ID and the destination ID. The operations of 1015 may be performed in accordance with examples as disclosed herein. In some examples, aspects of the operations of 1015 may be performed by a sidelink transmission manager 835 as described with reference to FIG. 8.

At 1020, the method may include monitoring for one or more distance-based feedback messages from the one or more receiving devices. The operations of 1020 may be performed in accordance with examples as disclosed herein. In some examples, aspects of the operations of 1020 may be performed by a distance-based feedback reception manager 840 as described with reference to FIG. 8.

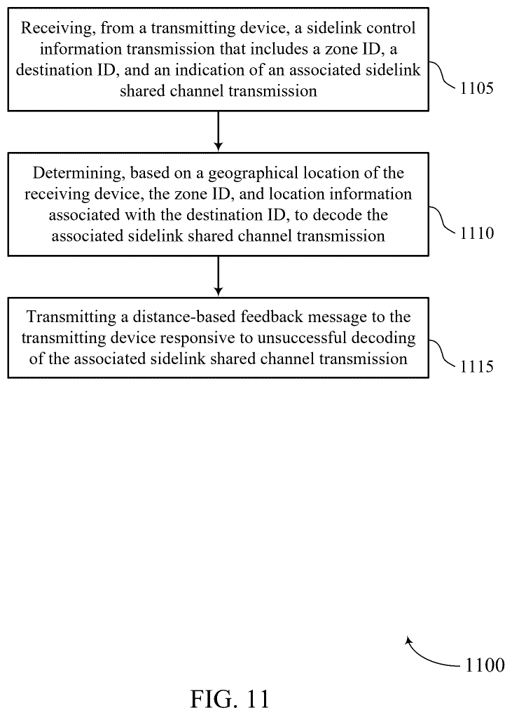

FIG. 11 illustrates a flowchart showing a method 1100 that supports techniques for distance based feedback for device-to-device communications in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving, from a transmitting device, an SCI transmission that includes a zone ID, a destination ID, and an indication of an associated sidelink shared channel transmission. The operations of 1105 may be performed in accordance with examples as disclosed herein. In some examples, aspects of the operations of 1105 may be performed by an SCI manager 845 as described with reference to FIG. 8.

At 1110, the method may include determining, based on a geographical location of the receiving device, the zone ID, and location information associated with the destination ID, to decode the associated sidelink shared channel transmission. The operations of 1110 may be performed in accordance with examples as disclosed herein. In some examples, aspects of the operations of 1110 may be performed by a sidelink reception manager 850 as described with reference to FIG. 8.

At 1115, the method may include transmitting a distance-based feedback message to the transmitting device responsive to unsuccessful decoding of the associated sidelink shared channel transmission. The operations of 1115 may be performed in accordance with examples as disclosed herein. In some examples, aspects of the operations of 1115 may be performed by a distance-based feedback transmission manager 855 as described with reference to FIG. 8.

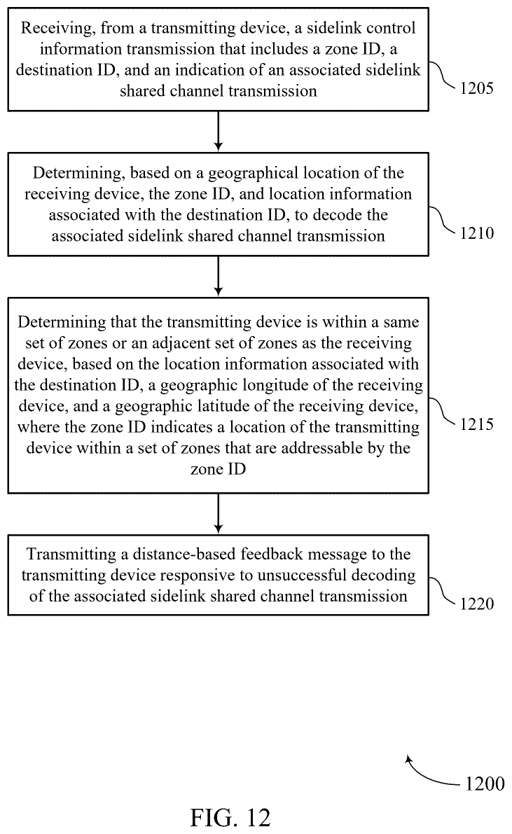

FIG. 12 illustrates a flowchart showing a method 1200 that supports techniques for distance based feedback for device-to-device communications in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving, from a transmitting device, an SCI transmission that includes a zone ID, a destination ID, and an indication of an associated sidelink shared channel transmission. The operations of 1205 may be performed in accordance with examples as disclosed herein. In some examples, aspects of the operations of 1205 may be performed by an SCI manager 845 as described with reference to FIG. 8.

At 1210, the method may include determining, based on a geographical location of the receiving device, the zone ID, and location information associated with the destination ID, to decode the associated sidelink shared channel transmission. The operations of 1210 may be performed in accordance with examples as disclosed herein. In some examples, aspects of the operations of 1210 may be performed by a sidelink reception manager 850 as described with reference to FIG. 8.

At 1215, the method may include determining that the transmitting device is within a same set of zones or an adjacent set of zones as the receiving device, based on the location information associated with the destination ID, a geographic longitude of the receiving device, and a geographic latitude of the receiving device, where the zone ID indicates a location of the transmitting device within a set of zones that are addressable by the zone ID. The operations of 1215 may be performed in accordance with examples as disclosed herein. In some examples, aspects of the operations of 1215 may be performed by a transmitting device zone manager 865 as described with reference to FIG. 8.

At 1220, the method may include transmitting a distance-based feedback message to the transmitting device responsive to unsuccessful decoding of the associated sidelink shared channel transmission. The operations of 1220 may be performed in accordance with examples as disclosed herein. In some examples, aspects of the operations of 1220 may be performed by a distance-based feedback transmission manager 855 as described with reference to FIG. 8.

The following provides an overview of aspects of the present disclosure:

Aspect 1: A method for wireless communication at a transmitting device, comprising: identifying a zone ID associated with a sidelink transmission; determining a destination ID for the sidelink transmission based at least in part on a longitude and a latitude of the transmitting device; transmitting the sidelink transmission to one or more receiving devices, the sidelink transmission including control information that indicates the zone ID and the destination ID; and monitoring for one or more distance-based feedback messages from the one or more receiving devices.

Aspect 2: The method of aspect 1, wherein the determining the destination ID comprises: determining a geographical longitude and a geographical latitude of the transmitting device; and determining a subset of bits of the destination ID based at least in part on the geographical longitude and the geographical latitude of the transmitting device.

Aspect 3: The method of any of aspects 1 through 2, wherein an application layer selects the destination ID from a range of available destination IDs for indicating a super-zone location of the transmitting device.

Aspect 4: The method of aspect 3, wherein a super-zone includes a union of a set of adjacent zones, each zone a square determined by latitude and longitude.

Aspect 5: The method of any of aspects 3 through 4, wherein the destination ID indicates the super-zone location of the transmitting device in a subset of bits associated with a geographical longitude and a geographical latitude of the transmitting device.

Aspect 6: The method of aspect 5, wherein the subset of bits includes four or five bits that provide an indication of the geographical longitude of the transmitting device and four or five bits that provide an indication of the geographical latitude of the transmitting device.

Aspect 7: The method of any of aspects 1 through 6, wherein location information associated with the destination ID indicates that a first receiving device of the one or more receiving devices having a location in an adjacent super-zone or a same super-zone associated with the zone ID is to provide distance-based feedback messages.

Aspect 8: The method of any of aspects 1 through 7, wherein a single zone size is associated with the zone ID and the destination ID.

Aspect 9: The method of any of aspects 1 through 8, wherein two or more different zone sizes are associated with the destination ID, and different ranges of destination ID values are associated with different zone sizes.

Aspect 10: The method of aspect 9, wherein the different ranges of destination ID values associated with different zone sizes are non-overlapping.

Aspect 11: A method for wireless communication at a receiving device, comprising: receiving, from a transmitting device, a SCI transmission that includes a zone ID, a destination ID, and an indication of an associated sidelink shared channel transmission; determining, based at least in part on a geographical location of the receiving device, the zone ID, and location information associated with the destination ID, to decode the associated sidelink shared channel transmission; and transmitting a distance-based feedback message to the transmitting device responsive to unsuccessful decoding of the associated sidelink shared channel transmission.

Aspect 12: The method of aspect 11, wherein the determining further comprises: determining that the transmitting device is within a same set of zones or an adjacent set of zones as the receiving device, based at least in part on the location information associated with the destination ID, a geographic longitude of the receiving device, and a geographic latitude of the receiving device, wherein the zone ID indicates a location of the transmitting device within a set of zones that are addressable by the zone ID.

Aspect 13: The method of aspect 12, wherein a set of destination IDs are indicated at an application layer of the receiving device that are associated with the set of zones and adjacent set of zones, and a distance between the receiving device and the transmitting device is determined at a layer of the receiving device that is lower than the application layer.

Aspect 14: The method of any of aspects 12 through 13, wherein the destination ID includes a set of bits and indicates the set of zones and adjacent set of zones associated with the transmitting device in a subset of the set of bits, the subset of bits associated with a geographical longitude and a geographical latitude of the transmitting device.

Aspect 15: The method of any of aspects 11 through 14, wherein the determining further comprises: determining, based at least in part on the destination ID, a quadrant of a set of zones associated with the transmitting device, wherein the zone ID indicates a location of the transmitting device within the set of zones that are addressable by the zone ID; and determining that the receiving device is located in the set of zones or in a different set zones that is adjacent to the quadrant of the set of zones associated with the transmitting device.

Aspect 16: The method of aspect 15, wherein the determining further comprises: determining that the distance-based feedback message is to be provided based at least in part on the receiving device being located in the set of zones or in the different set zones that is adjacent to the quadrant of the set of zones associated with the transmitting device.

Aspect 17: An apparatus for wireless communication at a transmitting device, comprising a processor; memory coupled with the processor; and instructions stored in the memory and executable by the processor to cause the apparatus to perform a method of any of aspects 1 through 10.

Aspect 18: An apparatus for wireless communication at a transmitting device, comprising at least one means for performing a method of any of aspects 1 through 10.

Aspect 19: A non-transitory computer-readable medium storing code for wireless communication at a transmitting device, the code comprising instructions executable by a processor to perform a method of any of aspects 1 through 10.

Aspect 20: An apparatus for wireless communication at a receiving device, comprising a processor; memory coupled with the processor; and instructions stored in the memory and executable by the processor to cause the apparatus to perform a method of any of aspects 11 through 16.

Aspect 21: An apparatus for wireless communication at a receiving device, comprising at least one means for performing a method of any of aspects 11 through 16.

Aspect 22: A non-transitory computer-readable medium storing code for wireless communication at a receiving device, the code comprising instructions executable by a processor to perform a method of any of aspects 11 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a transmitting device, comprising:
identifying a zone ID associated with a sidelink transmission;
determining a destination ID for the sidelink transmission based at least in part on a longitude and a latitude of the transmitting device;
transmitting the sidelink transmission to one or more receiving devices, the sidelink transmission including control information that indicates the zone ID and the destination ID; and
monitoring for one or more distance-based feedback messages from the one or more receiving devices.

2. The method of claim 1, wherein the determining the destination ID comprises:
determining a geographical longitude and a geographical latitude of the transmitting device; and
determining a subset of bits of the destination ID based at least in part on the geographical longitude and the geographical latitude of the transmitting device.

3. The method of claim 1, wherein an application layer selects the destination ID from a range of available destination IDs for indicating a super-zone location of the transmitting device.

4. The method of claim 3, wherein a super-zone includes a union of a set of adjacent zones, each zone a square determined by latitude and longitude.

5. The method of claim 3, wherein the destination ID indicates the super-zone location of the transmitting device in a subset of bits associated with a geographical longitude and a geographical latitude of the transmitting device.

6. The method of claim 5, wherein the subset of bits includes four or five bits that provide an indication of the geographical longitude of the transmitting device and four or five bits that provide an indication of the geographical latitude of the transmitting device.

7. The method of claim 1, wherein location information associated with the destination ID indicates that a first receiving device of the one or more receiving devices having a location in an adjacent super-zone or a same super-zone associated with the zone ID is to provide distance-based feedback messages.

8. The method of claim 1, wherein a single zone size is associated with the zone ID and the destination ID.

9. The method of claim 1, wherein:
two or more different zone sizes are associated with the destination ID, and
different ranges of destination ID values are associated with different zone sizes.

10. The method of claim 9, wherein the different ranges of destination ID values associated with different zone sizes are non-overlapping.

11. A method for wireless communication at a receiving device, comprising:
receiving, from a transmitting device, a sidelink control information transmission that includes a zone ID, a destination ID, and an indication of an associated sidelink shared channel transmission;
determining, based at least in part on a geographical location of the receiving device, the zone ID, and location information associated with the destination ID, to decode the associated sidelink shared channel transmission; and
transmitting a distance-based feedback message to the transmitting device responsive to unsuccessful decoding of the associated sidelink shared channel transmission.

12. The method of claim 11, wherein the determining further comprises:
determining that the transmitting device is within a same set of zones or an adjacent set of zones as the receiving device, based at least in part on the location information associated with the destination ID, a geographic longitude of the receiving device, and a geographic latitude of the receiving device, wherein the zone ID indicates a location of the transmitting device within a set of zones that are addressable by the zone ID.

13. The method of claim 12, wherein a set of destination IDs are indicated at an application layer of the receiving device that are associated with the set of zones and adjacent set of zones, and a distance between the receiving device and the transmitting device is determined at a layer of the receiving device that is lower than the application layer.

14. The method of claim 12, wherein the destination ID includes a set of bits and indicates the set of zones and adjacent set of zones associated with the transmitting device in a subset of the set of bits, the subset of bits associated with a geographical longitude and a geographical latitude of the transmitting device.

15. The method of claim 11, wherein the determining further comprises:
determining, based at least in part on the destination ID, a quadrant of a set of zones associated with the transmitting device, wherein the zone ID indicates a location of the transmitting device within the set of zones that are addressable by the zone ID; and
determining that the receiving device is located in the set of zones or in a different set zones that is adjacent to the quadrant of the set of zones associated with the transmitting device.

16. The method of claim 15, wherein the determining further comprises:
determining that the distance-based feedback message is to be provided based at least in part on the receiving device being located in the set of zones or in the different set zones that is adjacent to the quadrant of the set of zones associated with the transmitting device.

17. An apparatus for wireless communication at a transmitting device, comprising:
a processor,
memory coupled with the processor, and
instructions stored in the memory and executable by the processor to cause the apparatus to:
identify a zone ID associated with a sidelink transmission;
determine a destination ID for the sidelink transmission based at least in part on a longitude and a latitude of the transmitting device;
transmit the sidelink transmission to one or more receiving devices, the sidelink transmission including control information that indicates the zone ID and the destination ID; and
monitor for one or more distance-based feedback messages from the one or more receiving devices.

18. The apparatus of claim 17, wherein the instructions to determine the destination ID are executable by the processor to cause the apparatus to:
determine a geographical longitude and a geographical latitude of the transmitting device; and
determine a subset of bits of the destination ID based at least in part on the geographical longitude and the geographical latitude of the transmitting device.

19. The apparatus of claim 17, wherein an application layer selects the destination ID from a range of available destination IDs for indicating a super-zone location of the transmitting device.

20. The apparatus of claim 19, wherein a super-zone includes a union of a set of adjacent zones, each zone a square determined by latitude and longitude.

21-30. (canceled)
